(19) United States
(12) Patent Application Publication
(10) Pub. No.: US 2019/0270271 A1
(43) Pub. Date: Sep. 5, 2019

(54) POLYMERIC MULTILAYER FILM WITH OPENINGS

(71) Applicant: 3M INNOVATIVE PROPERTIES COMPANY, St. Paul, MN (US)

(72) Inventors: David F. Slama, City of Grant, MN (US); Garth V. Antila, Hudson, WI (US); Brent R. Hansen, New Richmond, WI (US); Graham M. Clarke, Woodbury, MN (US); Jeffrey O. Emslander, City of Grant, MN (US); John J. Rogers, St. Paul, MN (US); Jacob D. Young, St. Paul, MN (US)

(21) Appl. No.: 16/462,479

(22) PCT Filed: Nov. 8, 2017
(86) PCT No.: PCT/US2017/060544

§ 371 Date: May 20, 2019

Related U.S. Application Data
(60) Provisional application No. 62/427,887, filed on Nov. 30, 2016.

(51) Int. Cl. B32B 3/30; B32B 3/26; B32B 7/12; B32B 7/06; B32B 27/32; B32B 27/30; B32B 27/36; B32B 27/08; B32B 38/10; B32B 37/15

(52) U.S. Cl. CPC B32B 3/30; B32B 3/266; B32B 7/12; B32B 7/06; B32B 27/32; B32B 37/0053; B32B 27/36; B32B 27/08; B32B 38/10; B32B 37/153; B32B 27/302

(57) ABSTRACT

Polymeric multilayer films having an array of openings extending between the first and second major surfaces of the film, and a thickness greater than 50 micrometers, wherein the openings each have a series of areas through the openings from the first and second major surfaces ranging from minimum to maximum areas, and wherein the minimum area is not at at least one of the major surfaces. Polymeric multilayer films described herein are useful, for example, for wound dressings and graphics films.

### BACKGROUND

Films with openings and pressure sensitive adhesive coatings are known in the art. Uses for such films include graphic films adhered with the pressure sensitive adhesive to windows of buildings, vehicles, etc. For some embodiments of such films (e.g., tapes for medical applications and/or adherence to glass widows of buildings and vehicles) allow moisture from the skin to evaporate though the film. Perforated films for these applications are typically less than 150 micrometers (0.006 inch) thick and are made, for example, of olefin blends or polyvinylchloride.

Conventional methods for making films with openings include vacuum or pressurized fluid forming, laser processing, needle punching, and mechanical punching. These can be characterized into processes that either displace or remove material in order to form the opening.

For applications that require an adhesive layer as part of the product construction, the adhesive is typically applied to a substrate before the opening is created, either as a separate coating step or through the lamination of an adhesive coated liner. Processes creating openings that displace material can lead to undesirable issues such as adhesive build-up on the perforating equipment, additional thickness to perforate, and the possibility that the adhesive that is displaced during the perforation process reflows and closing up the perforations over time.

One method of applying adhesive to the film openings is to spray the adhesive in a random covering of narrow strands. With this method, however, the coverage of adhesive is not continuous and not visually acceptable if adhered to a transparent surface.

Additional film constructions with openings and pressure sensitive adhesive are desired.

### SUMMARY

In one aspect, the present disclosure provides a first polymeric multilayer film having first and second generally opposed major surfaces, the polymeric film comprising in order:
a layer comprising a pressure sensitive adhesive,
optionally a tie layer, and
a layer comprising a thermoplastic polymer,
   an array of openings extending between the first and second major surfaces, and a thickness greater than 50 micrometers (in some embodiments, greater than 75 micrometers, 100 micrometers, 125 micrometers, 150 micrometers, 200 micrometers, 250 micrometers, 500 micrometers, 750 micrometers, 1000 micrometers, 1500 micrometers, 2000 micrometers, or even at least 2500 micrometers; in some embodiments, in a range from 50 micrometers to 1500 micrometers, 125 micrometers to 1500 micrometers, or even 125 micrometers to 2500 micrometers), wherein there are at least 30 openings/cm² (in some embodiments, at least 50 openings/cm², 75 openings/cm², 100 openings/cm², 200 openings/cm², 250 openings/cm², 300 openings/cm², 400 openings/cm², 500 openings/cm², 600 openings/cm², 700 openings/cm², 750 openings/cm², 800 openings/cm², 900 openings/cm², 1000 openings/cm², 2000 openings/cm², 3000 openings/cm², or even least 4000 openings/cm²; in some embodiments, in a range from 30 openings/cm² to 200 openings/cm², 200 openings/cm² to 500 openings/cm², or even 500 openings/cm² to 4000 openings/cm²), wherein the openings each have a series of areas through the openings from the first and second major surfaces ranging from minimum to maximum areas, and wherein the minimum area is not at at least one of the major surfaces. In some embodiments, a liner layer is adjacent to the layer comprising pressure sensitive adhesive.

In another aspect, the present disclosure provides a method of making the polymeric multilayer film having a liner layer, the method comprising:

extruding at least the layer comprising pressure sensitive adhesive, optionally the tie layer, and the layer comprising thermoplastic polymer into a nip along with a liner layer to provide a polymeric multilayer film with a liner layer, wherein the nip comprises a first roll having a structured surface that imparts indentations through a first major surface of the polymeric multilayer film;

removing the liner; and

passing the first major surface having the indentations over a chill roll while applying a heat source to a generally opposed second major surface of the polymeric multilayer film, wherein the application of heat from the heat source results in formation of openings to provide the polymeric multilayer film with the liner layer. In some embodiments, the liner layer is subsequently separated from the extruded layers.

In another aspect, the present disclosure provides a second polymeric multilayer film having first and second generally opposed major surfaces, the polymeric film comprising in order:

a backing layer comprising a first thermoplastic polymer,

a layer comprising a pressure sensitive adhesive,

optionally a tie layer, and

a strippable layer comprising a second (in some embodiments, different) thermoplastic polymer,

an array of openings extending between the first and second major surfaces, and a thickness greater than 50 micrometers (in some embodiments, greater than 75 micrometers, 100 micrometers, 125 micrometers, 150 micrometers, 200 micrometers, 250 micrometers, 500 micrometers, 750 micrometers, 1000 micrometers, 1500 micrometers, 2000 micrometers, or even at least 2500 micrometers; in some embodiments, in a range from 50 micrometers to 1500 micrometers, 125 micrometers to 1500 micrometers, or even 125 micrometers to 2500 micrometers), wherein there are at least 30 openings/cm² (in some embodiments, at least 50 openings/cm², 75 openings/cm², 100 openings/cm², 200 openings/cm², 250 openings/cm², 300 openings/cm², 400 openings/cm², 500 openings/cm², 600 openings/cm², 700 openings/cm², 750 openings/cm², 800 openings/cm², 900 openings/cm², 1000 openings/cm², 2000 openings/cm², 3000 openings/cm², or even least 4000 openings/cm²; in some embodiments, in a range from 30 openings/cm² to 200 openings/cm², 200 openings/cm² to 500 openings/cm², or even 500 openings/cm² to 4000 openings/cm²), wherein the openings each have a series of areas through the openings from the first and second major surfaces ranging from minimum to maximum areas, wherein the minimum area is not at at least one of the major surfaces, wherein the polymeric layer is immiscible with the pressure sensitive adhesive, and wherein the strippable layer is removable from the layer comprising pressure sensitive adhesive at a peel force less than 200 grams per cm (in some embodiments, less than 150 grams per cm, 100 grams per cm, 50 grams per cm, or even less than 20 grams per cm) as determined by the Peel Test described in the Examples.

In another aspect, the present disclosure provides a method of making the second polymeric multilayer film, the method comprising:

extruding at least the backing layer comprising the first thermoplastic polymer, the layer comprising pressure sensitive adhesive, optionally the tie layer, and the strippable layer comprising the second thermoplastic polymer into a nip to provide a polymeric multilayer film, wherein the nip comprises a first roll having a structured surface that imparts indentations through a first major surface of the polymeric multilayer film; and

passing the first major surface having the indentations over a chill roll while applying a heat source to a generally opposed second major surface of the polymeric multilayer film, wherein the application of heat from the heat source results in formation of openings to provide the polymeric multilayer film. In some embodiments, the strippable layer is separated from the other extruded layers, including in some embodiments, removing the strippable layer before passing the first major surface having the indentations over the chill roll.

Polymeric multilayer films described herein are useful, for example, for medical dressings, or as graphics films.

### BRIEF DESCRIPTION OF THE DRAWINGS

FIG. 1A shows an intermediate of one exemplary polymeric multilayer film described herein.

FIG. 1B shows one exemplary polymeric multilayer film described herein.

FIG. 1C shows an exemplary apparatus for making the polymeric multilayer film shown in FIG. 1B.

FIG. 2A shows another intermediate exemplary polymeric multilayer film described herein.

FIG. 2B shows another exemplary polymeric multilayer film described herein.

FIG. 2C shows an exemplary apparatus for making the polymeric multilayer film shown in FIG. 2B.

### DETAILED DESCRIPTION

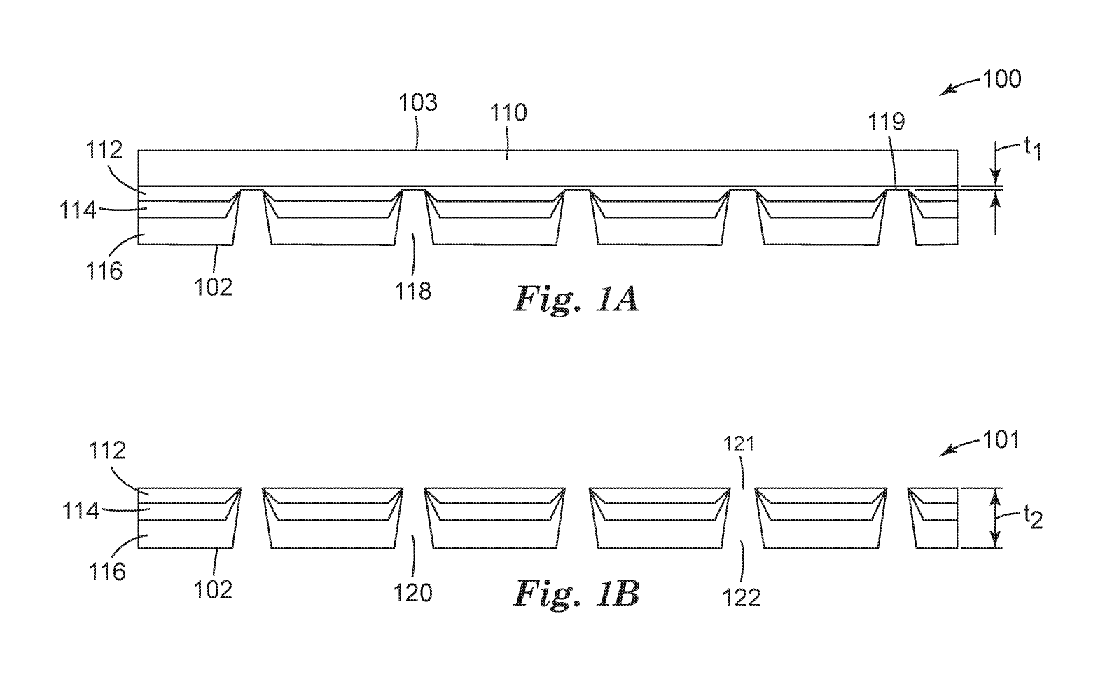

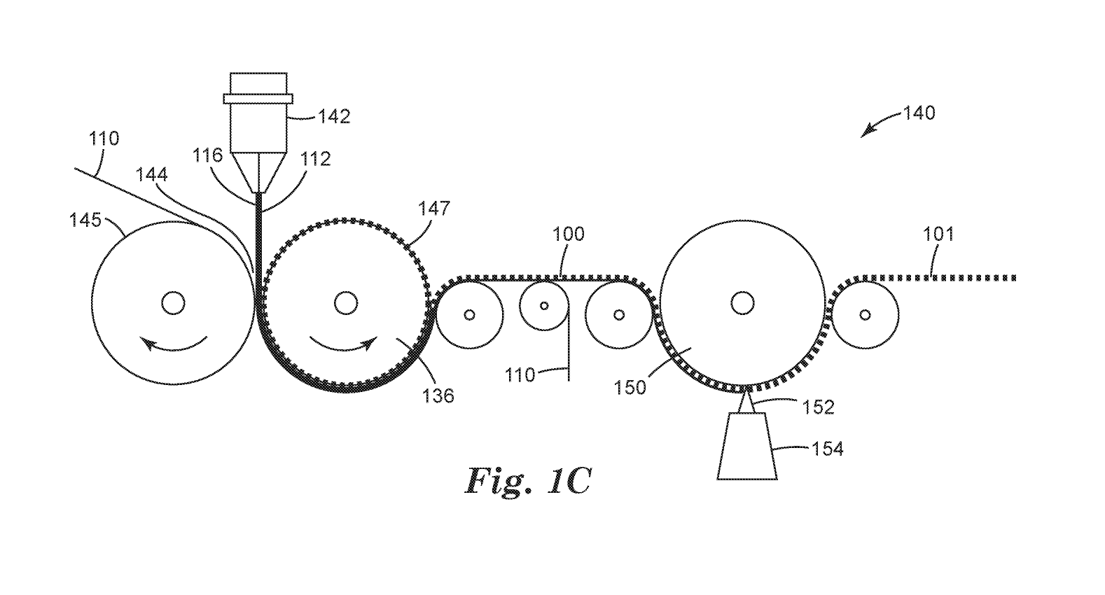

Referring to FIG. 1A, exemplary polymeric multilayer film 100 has first and second generally opposed major surfaces 102, 103. Polymeric multilayer film 100 has liner layer 110, pressure sensitive adhesive 112, optional tie layer 114, and layer comprising a thermoplastic polymer 116. Array of indentations 118 extends from first major surface 101 of polymeric multilayer film 100, wherein there are at least 30 indentations/cm². Optionally indentations 118 leave a thickness t₁ of material 119 comprising at least one of layers 112, 114 and 116, of less than 25 micrometers.

Referring to FIG. 1B, exemplary polymeric multilayer film 101 has first and second generally opposed major surfaces 102, 104. Polymeric multilayer film 101 has layer comprising pressure sensitive adhesive 112, and optional tie layer 114, and layer comprising a thermoplastic polymer 116. Array of openings 120 extends between first and second major surfaces 102, 104 of polymeric multilayer film 101, wherein there are at least 30 openings/cm². Openings 120 each have a series of areas through the openings from first and second major surfaces 102, 104 ranging from minimum to maximum areas 121, 122, respectively. Minimum area 121 is not at at least one of first or second major surfaces 102, 104. Polymeric multilayer film 101 thickness t2 is greater than 50 micrometers.

Referring to FIG. 1C, exemplary apparatus 140 for making polymeric multilayer film 101. At least two layers 112, 116 are extruded through die 142 into nip 144 at the same time as liner layer 110 is fed into nip 144 to provide polymeric film 100 with liner layer 110. Nip 144 comprises first roll 146 having structured surface 147 that imparts indentations 118 extending into at least first and second layers 112, 116 and providing polymeric multilayer film 100. The liner layer 110 is then removed from the extruded layers and the first major surface 102 having indentations 118 is passed over chill roll 150 while applying heat 152 from heat source 154 to the second major surface 104 of polymeric film 101. Application of heat 152 results in the formation of an array of openings 120 extending between first and second major surfaces 102, 104 of polymeric film 101.

Materials for making an apparatus for making polymeric multilayer films described herein include those known in the art for multilayer film making apparatuses, as well as materials used in the Examples, and/or materials apparent to those skilled in the art after reviewing the instant disclosure. For example, the rolls can be made of metals such as steel. In some embodiments, the surface of rolls contacting the polymeric material(s) are chrome plated, copper plated, or are aluminum. Rolls can be chilled, for example, using conventional techniques such as water cooling. Nip force can be provided, for example, by pneumatic cylinders.

In some embodiments, extrusion speeds include those in a range from 3-15 m/min. (in some embodiments, in a range from 15 to 50 m/min., 50 to 100 m/min., or more). In some embodiments, extrusion temperatures are in range from 200° C. to 230° C. (in some embodiments, in a range from 230° C. to 260° C., 260° C. to 300° C., or greater).

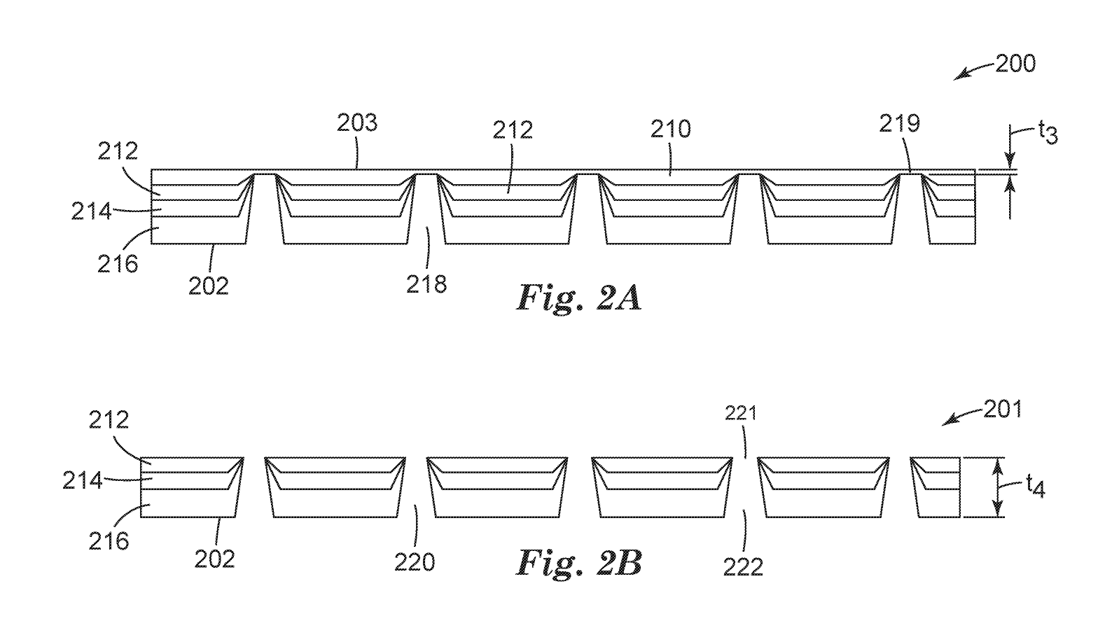

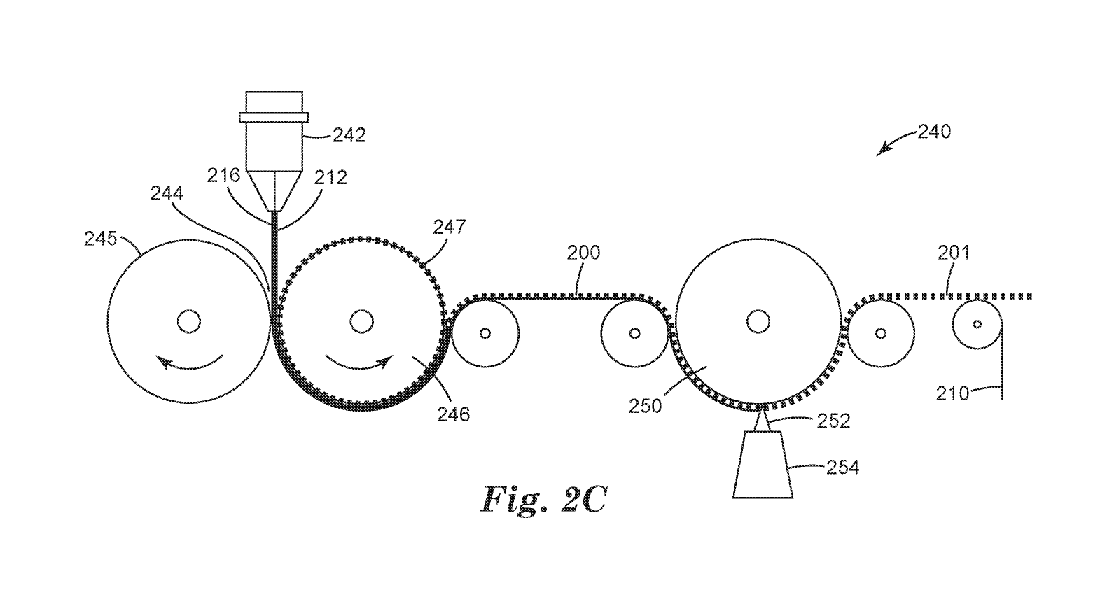

Referring to FIG. 2A, exemplary polymeric multilayer film 200 has first and second generally opposed major surfaces 202, 203. Polymeric multilayer film 200 has backing layer 202 comprising a first thermoplastic polymer, optional tie layer 214, layer comprising a pressure sensitive adhesive 212, and strippable layer comprising a second thermoplastic polymer 210. Layer 210 is immiscible with pressure sensitive adhesive 212. Strippable layer 210 is removable from pressure sensitive adhesive layer 212 at a peel force less than 200 grams per cm (in some embodiments, less than 150 grams per cm, 100 grams per cm, 50 grams per cm, or even less than 20 grams per cm) as determined by the Peel Test described in the Examples. Array of indentations 218 extend from first major surface 202 of polymeric multilayer film 200, wherein there are at least 30 indentations/cm². Optionally, indentations 218 leave a thickness t3 of material 219 comprising at least one of layers 112, 114, and 116, of less than 25 micrometers.

Referring to FIG. 2B, exemplary polymeric multilayer film 101 has first and second generally opposed major surfaces 202, 204. Polymeric multilayer film 201 has layer 216 comprising a first thermoplastic polymer, optional tie layer 214, and layer comprising a pressure sensitive adhesive 212. Array of openings 220 extends between first and second major surfaces 202, 204 of polymeric multilayer film 201, wherein there are at least 30 openings/cm². Openings 220 each have a series of areas through the openings from first and second major surfaces 102, 104 ranging from minimum to maximum areas 221, 222, respectively. Minimum area 221 is not at at least one of first or second major surfaces 202, 204. Polymeric multilayer film 201 thickness t4 is greater than 50 micrometers.

Referring to FIG. 2C, exemplary apparatus 240 for making polymeric multilayer film 201. At least two layers 212, 216 are extruded through die 242 into nip 244 to provide polymeric film 200. Nip 244 comprises first roll 246 having structured surface 247 that imparts indentations 218 extending into at least first and second layers 212, 216, and providing polymeric multilayer film 200. The strippable layer 210 is then removed from the extruded layers and the first major surface 202 having indentations 218 is passed over chill roll 250 while applying heat 252 from heat source 254 to the second major surface 204 of polymeric film 201. Application of heat 252 results in the formation of an array of openings 220 extending between first and second major surfaces 202, 204 of polymeric film 201.

Exemplary pressure sensitive adhesive (PSA) includes tackified natural rubbers, synthetic rubbers, tackified styrene block copolymers, polyvinyl ethers, acrylics, poly-a-olefins, and silicones, and acrylate-based PSA's (including those described, for example, in U.S. Pat. No. 4,181,752 (Clemens et al.) and U.S. Pat. No. 4,418,120 (Kealy et al.), PCT Pub. No. WO 95/13331, and in Handbook of Pressure-Sensitive Adhesives Technology, Ed. D. Satas, 2nd Edition, Von Nostrand Reinhold, New York, 1989).

Exemplary tie layer materials include ethylene methyl acrylate (EMA) copolymers, ethylene acrylic acid (EAA) copolymers, ethylene butyl acrylate (EBA) copolymers, ethylene vinyl acetate (EVA), ethylene acid terpolymers, polybutene (PB), and polymethylpentenes (PMP). As is understood by one skilled in the art, a suitable tie layer material is chosen to aid in bonding the chosen thermoplastic polymer layer and pressure sensitive adhesive together.

Exemplary thermoplastic polymers for the backing layer include polyamide 6, polyamide 66, polyethyleneterephthalate (PET), copolyester (PETg), cellulose acetobutyrate (CAB), 30 polymethylmethacrylate (PMMA), acrylonitrile butadiene styrene (ABS), polyolefin copolymers, polyethylene, polystyrene (PS), ethylene vinyl alcohol (EVOH), polycarbonate (PC), polybutyleneterephthalate (PBT), polyethylenenaphthalate (PEN), and polypropylene.

Exemplary thermoplastic polymers for the strippable layer include at least one olefinic block copolymers. Exemplary alpha-olefins include at least one of butene-1 alpha-olefin, a hexene-1 alpha-olefin, or octene-1 alpha-olefin. Generally, copolymers of ethylene and octene-1 are used as release layers, for example, with acrylate-based pressure sensitive adhesives. The copolymers are generically described as olefinic block copolymers. Typically, the copolymers have a density up to 0.90 g/cm³ (in some embodiments, up to 0.89 g/cm³, or even up to 0.88 g/cm³; in some embodiments, in a range from 0.85 g/cm³ to 0.90 g/cm³, 0.85 g/cm³ to 0.89 g/cm³, or even 0.85 g/cm³ to 0.88 g/cm³). In some embodiments, the copolymers may be blended with other olefinic polymers (e.g., polyethylene) to increase the elastic modulus of the strippable layer in order to reduce elongation of the layer during removal of the layer from the film. Exemplary polyethylenes include low density polyethylene (LDPE) (i.e., in a range from 0.910 g/cm³ to 0.925 g/cm³), medium density polyethylene (MDPE) (i.e., in a range from 0.926 g/cm³ to 0.940 g/cm³), and high density polyethylene (HDPE) (i.e., at least 0.941 g/cm³). In some embodiments, the percentage of added polyethylene, by mass, is up to 10% (in some embodiments, up to 20%, 30%, 40%, or even up to 50%).

In some embodiments, at least one layer of a polymeric multilayer films described herein may include an additive such as inorganic fillers, pigments, slip agents, and flame retardants. Such additives are known in the art and used in some polymeric multilayer films.

The liner layer can be made, for example, from polyethylene terephthalate (PET), polyethylene napthalate (PEN), polycarbonate or other suitable polymers.

In some embodiments, polymeric multilayer films described herein have a thickness greater than 50 micrometers (in some embodiments, greater than 75 micrometers, 100 micrometers, 125 micrometers, 150 micrometers, 200 micrometers, 250 micrometers, 500 micrometers, 750 micrometers, 1000 micrometers, 1500 micrometers, 2000 micrometers, or even at least 2500 micrometers; in some embodiments, in a range from 50 micrometers to 1500 micrometers, 125 micrometers to 1500 micrometers, or even 125 micrometers to 2500 micrometers).

In some embodiments, polymeric multilayer films described herein have at least 50 openings/cm² (in some embodiments, 75 openings/cm², 100 openings/cm², 200 openings/cm², 250 openings/cm², 300 openings/cm², 400 openings/cm², 500 openings/cm², 600 openings/cm², 700 openings/cm², 750 openings/cm², 800 openings/cm², 900 openings/cm², 1000 openings/cm², 2000 openings/cm², 3000 openings/cm², or even least 4000 openings/cm²; in some embodiments, in a range from 30 openings/cm² to 200 openings/cm², 200 openings/cm² to 500 openings/cm², or even 500 openings/cm² to 4000 openings/cm²).

In some embodiments, the openings have a largest dimension of at least 50 micrometers (in some embodiments, at least 75 micrometers, 100 micrometers, 125 micrometers, 150 micrometers, 250 micrometers, 500 micrometers, or 1000 micrometers; in some embodiments, in a range from 50 micrometers to 100 micrometers, 50 micrometers to 150 micrometers, 50 micrometers, to 250 micrometers, 100 micrometers to 250 micrometers, 250 micrometers to 500 micrometers, 500 micrometers to 1000 micrometers, 50 micrometers to 1000 micrometers, or even 100 micrometers to 1000 micrometers).

Polymeric multilayer films described herein are useful, for example, for medical tapes and dressings.

### Exemplary Embodiments

1A. A polymeric multilayer film having first and second generally opposed major surfaces, the polymeric film comprising in order:

a layer comprising a pressure sensitive adhesive,

optionally a tie layer, and

a layer comprising a thermoplastic polymer,

an array of openings extending between the first and second major surfaces, and a thickness greater than 50 micrometers (in some embodiments, greater than 75 micrometers, 100 micrometers, 125 micrometers, 150 micrometers, 200 micrometers, 250 micrometers, 500 micrometers, 750 micrometers, 1000 micrometers, 1500 micrometers, 2000 micrometers, or even at least 2500 micrometers; in some embodiments, in a range from 50 micrometers to 1500 micrometers, 125 micrometers to 1500 micrometers, or even 125 micrometers to 2500 micrometers), wherein there are at least 30 openings/cm² (in some embodiments, at least 50 openings/cm², 75 openings/cm², 100 openings/cm², 200 openings/cm², 250 openings/cm², 300 openings/cm², 400 openings/cm², 500 openings/cm², 600 openings/cm², 700 openings/cm², 750 openings/cm², 800 openings/cm², 900 openings/cm², 1000 openings/cm², 2000 openings/cm², 3000 openings/cm², or even least 4000 openings/cm²; in some embodiments, in a range from 30 openings/cm² to 200 openings/cm², 200 openings/cm² to 500 openings/cm², or even 500 openings/cm² to 4000 openings/cm²), wherein the openings each have a series of areas through the openings from the first and second major surfaces ranging from minimum to maximum areas, and wherein the minimum area is not at at least one of the major surfaces.
2A. The polymeric multilayer film of Exemplary Embodiment 1A, wherein the openings have a largest dimension of at least 50 micrometers (in some embodiments, at least 75 micrometers, 100 micrometers, 125 micrometers, 150 micrometers, 250 micrometers, 500 micrometers, or 1000 micrometers; in some embodiments, in a range from 50 micrometers to 100 micrometers, 50 micrometers to 150 micrometers, 50 micrometers, to 250 micrometers, 100 micrometers to 250 micrometers, 250 micrometers to 500 micrometers, 500 micrometers to 1000 micrometers, 50 micrometers to 1000 micrometers, or even 100 micrometers to 1000 micrometers).
3A. The polymeric multilayer film of any preceding A Exemplary Embodiment, wherein the tie layer comprises at least one of an ethylene methyl acrylate (EMA) copolymer, ethylene acrylic acid (EAA) copolymer, ethylene butyl acrylate (EBA) copolymer, ethylene vinyl acetate (EVA), ethylene acid terpolymer, polybutene (PB), or polymethylpentene (PMP).
4A. The polymeric multilayer film of any preceding A Exemplary Embodiment, wherein the pressure sensitive adhesive comprises at least one of a natural rubber, a synthetic rubber, a styrene block copolymer, a polyvinyl ether, an acrylic, a poly-a-olefin, a silicone, or an acrylate.
5A. The polymeric multilayer film of any preceding A Exemplary Embodiment, wherein the thermoplastic polymer is at least one of polyamide 6, polyamide 66, polyethyleneterephthalate (PET), copolyester (PETg), cellulose acetobutyrate (CAB), 30 polymethylmethacrylate (PMMA), acrylonitrile butadiene styrene (ABS), polyolefin copolymers, polyethylene, polystyrene (PS), ethylene vinyl alcohol (EVOH), polycarbonate (PC), polybutyleneterephthalate (PBT), polyethylenenaphthalate (PEN), or polypropylene.
6A. An article comprising the polymeric multilayer film of any preceding A Exemplary Embodiment and a liner layer adjacent the layer comprising pressure sensitive adhesive, such that the order of the layer is:

the liner layer,

the layer comprising pressure sensitive adhesive,

optionally the tie layer, and

the layer comprising thermoplastic polymer.

7A. The polymeric multilayer film of any preceding A Exemplary Embodiment, wherein the liner layer comprises at least one of polyethylene terephthalate (PET), polyethylene napthalate (PEN), or polycarbonate.
1B. A method of making a polymeric multilayer film, the method comprising:

extruding at least the layer comprising pressure sensitive adhesive, optionally the tie layer, and the layer comprising thermoplastic polymer into a nip along with a liner layer to provide a polymeric multilayer film with a liner layer, wherein the nip comprises a first roll having a structured surface that imparts indentations through a first major surface of the polymeric multilayer film;

removing the liner; and

passing the first major surface having the indentations over a chill roll while applying a heat source to a generally opposed second major surface of the polymeric multilayer film, wherein the application of heat from the heat source results in formation of openings to provide the polymeric multilayer film of either Exemplary Embodiment 6A or 7A.

1C. A polymeric multilayer film having first and second generally opposed major surfaces, the polymeric film comprising in order:

a backing layer comprising a first thermoplastic polymer,

a layer comprising a pressure sensitive adhesive,

optionally a tie layer, and

a strippable layer comprising a second (in some embodiments, different) thermoplastic polymer,

an array of openings extending between the first and second major surfaces, and a thickness greater than 50 micrometers (in some embodiments, greater than 75 micrometers, 100 micrometers, 125 micrometers, 150 micrometers, 200 micrometers, 250 micrometers, 500 micrometers, 750 micrometers, 1000 micrometers, 1500 micrometers, 2000 micrometers, or even at least 2500 micrometers; in some embodiments, in a range from 50 micrometers to 1500 micrometers, 125 micrometers to 1500 micrometers, or even 125 micrometers to 2500 micrometers), wherein there are at least 30 openings/cm² (in some embodiments, at least 50 openings/cm², 75 openings/cm², 100 openings/cm², 200 openings/cm², 250 openings/cm², 300 openings/cm², 400 openings/cm², 500 openings/cm², 600 openings/cm², 700 openings/cm², 750 openings/cm², 800 openings/cm², 900 openings/cm², 1000 openings/cm², 2000 openings/cm², 3000 openings/cm², or even least 4000 openings/cm²; in some embodiments, in a range from 30 openings/cm² to 200 openings/cm², 200 openings/cm² to 500 openings/cm², or even 500 openings/cm² to 4000 openings/cm²), wherein the openings each have a series of areas through the openings from the first and second major surfaces ranging from minimum to maximum areas, wherein the minimum area is not at at least one of the major surfaces, wherein the polymeric layer is immiscible with the pressure sensitive adhesive, and wherein the strippable layer is removable from the layer comprising pressure sensitive adhesive at a peel force less than 100 grams per cm (in some embodiments, less than 50 grams per cm, or even less than 20 grams per cm) as determined by the Peel Test described in the Examples.
2C. The polymeric multilayer film of Exemplary Embodiment 1C, wherein the openings have a largest dimension of at least 50 micrometers (in some embodiments, at least 75 micrometers, 100 micrometers, 125 micrometers, 150 micrometers, 250 micrometers, 500 micrometers, or 1000 micrometers; in some embodiments, in a range from 50 micrometers to 100 micrometers, 50 micrometers to 150 micrometers, 50 micrometers, to 250 micrometers, 100 micrometers to 250 micrometers, 250 micrometers to 500 micrometers, 500 micrometers to 1000 micrometers, 50 micrometers to 1000 micrometers, or even 100 micrometers to 1000 micrometers).
3C. The polymeric multilayer film of any preceding C Exemplary Embodiment, wherein the tie layer comprises at least one of an ethylene methyl acrylate (EMA) copolymer, ethylene acrylic acid (EAA) copolymer, ethylene butyl acrylate (EBA) copolymer, ethylene vinyl acetate (EVA), ethylene acid terpolymer, polybutene (PB), or polymethylpentene (PMP).
4C. The polymeric multilayer film of any preceding C Exemplary Embodiment, wherein the pressure sensitive adhesive comprises at least one of a natural rubber, a synthetic rubber, a styrene block copolymer, a polyvinyl ether, an acrylic, a poly-a-olefin, a silicone, or an acrylate.
5C. The polymeric multilayer film of any preceding C Exemplary Embodiment, wherein the thermoplastic polymer is at least one of polyamide 6, polyamide 66, polyethyleneterephthalate (PET), copolyester (PETg), cellulose acetobutyrate (CAB), 30 polymethylmethacrylate (PMMA), acrylonitrile butadiene styrene (ABS), polyolefin copolymers, polyethylene, and polystyrene (PS), ethylene vinyl alcohol (EVOH), polycarbonate (PC), polybutyleneterephthalate (PBT), polyethylenenaphthalate (PEN), or polypropylene.
1D. A method of making a polymeric multilayer film, the method comprising:

extruding at least the backing layer comprising the first thermoplastic polymer, the layer comprising pressure sensitive adhesive, optionally the tie layer, and the strippable layer comprising the second thermoplastic polymer into a nip to provide a polymeric multilayer film, wherein the nip comprises a first roll having a structured surface that imparts indentations through a first major surface of the polymeric multilayer film; and

passing the first major surface having the indentations over a chill roll while applying a heat source to a generally opposed second major surface of the polymeric multilayer film, wherein the application of heat from the heat source results in formation of openings to provide the polymeric multilayer film of any of Exemplary Embodiments 1C to 5C.

2D. The method of Exemplary Embodiment 1D further comprising removing the strippable layer from the other extruded layers.
3D. The method of Exemplary Embodiment 2D further comprising removing the strippable layer from the other extruded layers before passing the first major surface having the indentations, over the chill roll.
4D. The polymeric multilayer film of any preceding D Exemplary Embodiment, wherein the strippable layer comprises at least one of a butene-1 alpha-olefin, a hexene-1 alpha-olefin, or octene-1 alpha-olefin.
5D. The polymeric multilayer film of Exemplary Embodiment 4D, further comprising a polyethylene.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### Peel Test

The peel force between two layers of a polymeric multilayer film was determined as follows. A strip about 2.54 cm wide and at least 30 cm long was cut from the film. The strip was applied to a rigid plate that was fixed to the flat test bed of a testing machine (obtained under the trade designation “IMASS MODEL SP2000” from IMass Inc., Accord, Mass.), using double-sided tape (obtained under the trade designation “LSE300” from 3M, Maplewood Minn.), with the adhesive tape applied to the surface of the film that was contacting the structured roll in the nip. The leading edge of the strippable layer or liner was then separated from the film and clamped to a fixture connected to the peel-tester load-cell. The platen holding the plate/test-strip assembly was then carried away from the load-cell at constant speed of about 228 cm/minute (90 inches/minute), effectively peeling the strippable skin layer from the film at about a 180 degree angle. As the platen moves away from the clamp, the force required to peel the strippable skin layer off the film was sensed by the load cell and recorded by a microprocessor. The force required for peel was then averaged over 5 seconds of steady-state travel and recorded. There was a delay of 1 second from the start of the movement of the platen before recording the 5 seconds of data in order to remove any initial high force values generated at the start of the peel.

### Example 1

Referring to FIGS. 1A, 1B, and 1C, a perforated multilayer polymeric film (101) was prepared as follows. A three layer polymeric film consisting of layers A, B, and C (ABC) was prepared using three extruders to feed a 25 cm wide, 3 layer multi-manifold die (142) (obtained under the trade designation “CLOEREN” from Cloeren Inc., Orange, Tex.). The extrusion process was done horizontally into a nip (144) with a tooling roll (146) and backup roll (145). The extrusion process was configured such that layer A contacted the tooling roll (146) and layer C contacted the backup roll (145), as shown in FIG. 1C. The polymer for layer A was provided with a 6.35 cm single screw extruder. The polymer for layer B was provided with a 208 liter (55 gallon) adhesive drum unloader and 5 cm³ size gear pump. The polymer for layer C was provided with a 3.2 cm single screw extruder. Heating zone temperatures for the extruders drum unloader, and die, and the rpms for the extruders are shown in Table 1, below.

TABLE 1

| | 6.35 cm | | 3.2 cm | |
|---|---|---|---|---|
| | (2.5 inch) | Drum Unloader | (1.25 inch) | Die, |
| Heating Zones | Layer A, ° C. | Layer B, ° C. | Layer C, ° C. | ° C. |
| Zone 1 | 193 | 204 | 191 | 210 |
| Zone 2 | 204 | 204 | 204 | 210 |
| Zone 3 | 210 | N/A | 210 | 210 |
| Zone 4 | 210 | N/A | N/A | N/A |
| End cap | 210 | N/A | 210 | N/A |
| Neck Tube | 210 | 210 | 210 | N/A |
| Platen | N/A | 210 | N/A | N/A |
| Manifold | N/A | 210 | N/A | N/A |

The rpms of the extruders are listed in Table 2, below.

TABLE 2

| | 6.35 cm | | 3.2 cm |
|---|---|---|---|
| | (2.5 inch) | Gear Pump | (1.25 inch) |
| | Layer A | Layer B | Layer C |
| Rpm | 18 | 2.8 | 20 |

Referring to FIGS. 2A, 2B, and 2C, layer A (216) was extruded using polypropylene/polyethylene impact copolymer (35 melt flow rate; obtained under the trade designation “DOW C700 35N” from Braskem PP Americas, Philadelphia, Pa.). Layer B (212) was extruded using pressure sensitive adhesive, a 50:50 by weight mixture of styrene-isoprene-styrene block copolymer (obtained under the trade designation “KRATON 1161” from Kraton Performance Polymers Co., Houston, Tex.) and tackifying resin (obtained under the trade designation “WINGTACK+” from Total Petrochemicals USA, Inc., Port Arthur, Tex.). Layer C (210) was extruded using olefin block copolymer resin (obtained under the trade designation “INFUSE 9507” from Dow Chemical Company, Midland, Mich.).

The two rolls providing the nip were water cooled rolls (245, 246) with face widths of 30.5 cm. The tooling roll (246) having a nominal diameter of 30.5 cm. The backup roll (245) having a nominal diameter of 31.6 cm, including a 1.3 cm thick outer covering of an 85 Shore A durometer silicone rubber. The tooling roll (246) had a temperature setpoint of 46° C. and the backup roll (245) had a temperature set point of 16° C. The tooling roll (246) had male post features (247) cut into the surface of the roll. The male post features were chrome plated. The male features (defined as posts) (247) on the tool surface were flat square topped pyramids with a square base. The top of the posts were 102 micrometers square and the bases were 293 micrometers square. The overall post height was 432 micrometers. The center to center spacing of the posts was 1834 micrometers in both the radial and cross roll directions. The backup roll (245) had a temperature set point of 38° C. The tooling roll (246) and backup roll (245) were directly driven. The nip force between the two nip rolls was 117 Newtons per linear centimeter. The extrudate takeaway line speed was 7.6 m/min.

The polymers for the three layers were extruded from the die (242) directly into the nip (244) between the tooling (246) and backup roll (245). The male features (247) on the tooling roll (246) created indentations (218) in the extrudate. A thin layer of polymer (219) remained between the tooling (246) and backup roll (245). Typically this layer (219) was less than 20 micrometer thick. The extrudate remained on the tooling roll (246) for 180 degrees of wrap to chill and solidify the extrudate into a multi-layer polymeric film. The multi-layer film was then wound into roll form.

The multi-layer polymeric film was then converted into a perforated film as follows. The film was passed under a methylacetylene-propadiene propane flame from a handheld torch at a speed of about 7.6 m/min, at a distance of about 5.0 cm with the membrane towards the flame. The resulting film contained perforations of about 147 micrometers diameter. Layer C was then removed from the film with the peel test measuring the force as 87 g/cm.

### Example 2

Example 2 was prepared as described for Example 1, except that prior to converting into a perforated film, Layer C was removed from the film. The peel test measured the peel force of removing Layer C as 81 g/cm. The resulting film contained perforations of about 95 micrometers diameter.

### Example 3

Example 3 was prepared as described for Example 1, except that Layer C was not extruded through the die, so that only Layers A and B were extruded into the nip. In addition, a polyethylene terephthalate (PET) liner (110) 0.05 mm thick with silicone release coating applied to one side was introduced into the nip (144) by wrapping 90 degrees around the nip roll with the release coating side contacting Layer B upon entering the nip.

The multilayer polymeric film was then converted into a perforated film as in Example 2, except that the PET liner layer (110) was removed from the film prior to creating the perforations as in Example 1. The resulting film contained perforations of about 152 micrometers diameter. The peel test measured the peel force of removing the liner layer (110) as 34 g/cm.

Foreseeable modifications and alterations of this disclosure will be apparent to those skilled in the art without departing from the scope and spirit of this invention. This invention should not be restricted to the embodiments that are set forth in this application for illustrative purposes.

1. A polymeric multilayer film having first and second generally opposed major surfaces, the polymeric film comprising in order:
a layer comprising a pressure sensitive adhesive,
optionally a tie layer, and
a layer comprising a thermoplastic polymer,
an array of openings extending between the first and second major surfaces, and a thickness greater than 50 micrometers, wherein the openings each have a series of areas through the openings from the first and second major surfaces ranging from minimum to maximum areas, and wherein the minimum area is not at at least one of the major surfaces.

2. The polymeric multilayer film of claim 1, wherein the openings have a largest dimension of at least 50 micrometers.

3. The polymeric multilayer film of claim 1, wherein the openings have a largest dimension in a range from 50 micrometers to 1000 micrometers.

4. The polymeric multilayer film of claim 1 that includes the tie layer.

5. The polymeric multilayer film of claim 4, wherein the tie layer comprises at least one of an ethylene methyl acrylate copolymer, ethylene acrylic acid copolymer, ethylene butyl acrylate copolymer, ethylene vinyl acetate, ethylene acid terpolymer, polybutene, or polymethylpentene.

6. The polymeric multilayer film of claim 1, wherein the pressure sensitive adhesive comprises at least one of a natural rubber, a synthetic rubber, a styrene block copolymer, a polyvinyl ether, an acrylic, a poly-a-olefin, a silicone, or an acrylate.

7. The polymeric multilayer film of claim 1, wherein the thermoplastic polymer is at least one of polyamide 6, polyamide 66, polyethylene terephthalate, copolyester, cellulose acetobutyrate, 30 polymethylmethacrylate, acrylonitrile butadiene styrene, polyolefin copolymers, polyethylene, and polystyrene, ethylene vinyl alcohol, polycarbonate, polybutyleneterephthalate, polyethylenenaphthalate, or polypropylene.

8. An article comprising the polymeric multilayer film of claim 1 and a liner layer adjacent the layer comprising pressure sensitive adhesive, such that the order of the layer is:
the liner layer,
the layer comprising pressure sensitive adhesive,
optionally the tie layer, and
the layer comprising thermoplastic polymer.

9. A method of making a polymeric multilayer film, the method comprising:
extruding at least the layer comprising pressure sensitive adhesive, optionally the tie layer, and the layer comprising thermoplastic polymer into a nip along with a liner layer to provide a polymeric multilayer film with a liner layer, wherein the nip comprises a first roll having a structured surface that imparts indentations through a first major surface of the polymeric multilayer film;
removing the liner; and
passing the first major surface having the indentations over a chill roll while applying a heat source to a generally opposed second major surface of the polymeric multilayer film, wherein the application of heat from the heat source results in formation of openings to provide the polymeric multilayer film of claim 8.

10. A polymeric multilayer film having first and second generally opposed major surfaces, the polymeric film comprising in order:
a backing layer comprising a first thermoplastic polymer,
a layer comprising a pressure sensitive adhesive,
optionally a tie layer, and
a strippable layer comprising a second thermoplastic polymer,
an array of openings extending between the first and second major surfaces, and a thickness greater than 50 micrometers, wherein the openings each have a series of areas through the openings from the first and second major surfaces ranging from minimum to maximum areas, wherein the minimum area is not at at least one of the major surfaces, wherein the polymeric layer is immiscible with the pressure sensitive adhesive, and wherein the strippable layer is removable from the layer comprising pressure sensitive adhesive at a peel force less than 200 grams per cm as determined by the Peel Test described in the Examples.

11. The polymeric multilayer film of claim 10, wherein the openings have a largest dimension of at least 50 micrometers.

12. The polymeric multilayer film of claim 10, wherein the openings have a largest dimension in a range from 50 micrometers to 1000 micrometers.

13. The polymeric multilayer film of claim 9 that includes the tie layer.

14. A method of making a polymeric multilayer film, the method comprising:
extruding at least the backing layer comprising the first thermoplastic polymer, the layer comprising pressure sensitive adhesive, optionally the tie layer, and the strippable layer comprising the second thermoplastic polymer into a nip to provide a polymeric multilayer film, wherein the nip comprises a first roll having a structured surface that imparts indentations through a first major surface of the polymeric multilayer film; and
passing the first major surface having the indentations over a chill roll while applying a heat source to a generally opposed second major surface of the polymeric multilayer film, wherein the application of heat from the heat source results in formation of openings to provide the polymeric multilayer film of claim 10.

15. The method of claim 14 further comprising removing the strippable layer from the other extruded layers.

16. The method of claim 14 further comprising removing the strippable layer from the other extruded layers before passing the first major surface having the indentations, over a chill roll.
